(19) United States
(12) Patent Application Publication
(10) Pub. No.: US 2019/0383352 A1
(43) Pub. Date: Dec. 19, 2019

(54) TORSION DAMPER AND MOTOR VEHICLE

(71) Applicant: VALEO KAPEC CO., LTD., Daegu (KR)

(72) Inventor: Michael HENNEBELLE, Amiens Cedex 2 (FR)

(21) Appl. No.: 16/472,063

(22) PCT Filed: Dec. 20, 2017
(86) PCT No.: PCT/IB2017/058229

§ 371 Date: Jun. 20, 2019

(30) Foreign Application Priority Data
Dec. 20, 2016 (FR) 16/62828

(51) Int. Cl. F16F 15/123; F16F 15/121; F16F 15/24

(52) U.S. Cl. CPC F16F 15/12366; F16F 15/24; F16F 15/1216

(57) ABSTRACT

The present invention concerns a torsion damper (1) between an input first element (3) and an output second element (5) mounted mobile in rotation relative to one another about a rotation axis X, comprising:
at least one internal first spring (7),
at least one external second spring (9),
a first guide washer (11, 11″) of the at least one internal first spring (7),
a second guide washer (13, 13″) of the at least one external second spring (9),
   in which one of the guide washers (11, 11″, 13, 13″) includes at least one phasing member (110, 112) configured to come into contact with the at least one spring (7, 9) guided by the other guide washer (11, 11″, 13, 13″) to take up the force transmitted by said at least one spring (7, 9) guided by the other guide washer (11, 11″, 13, 13″).

The present invention concerns a torsion damper, notably for motor vehicles.

Internal combustion engines do not generate a constant torque and are subject to acyclic phenomena caused by the successive explosions inside their cylinders. These acyclic phenomena generate vibrations that can be transmitted to the gearbox and thus generate particularly undesirable shocks, noise and noise problems. In order to reduce the undesirable effects of the vibrations and to improve the comfort of the driver of motor vehicles it is known to equip motor vehicle transmissions with torsion dampers.

Torsion dampers generally comprise a primary element and a secondary element mobile in rotation relative to one another about a rotation axis. Torsion dampers also further include damping spring means disposed between the primary element and the secondary element to damp the acyclic phenomena.

However, the stiffnesses and the relative movement of the elastic means have to be adjusted as a function of the torque supplied by the engines. Thus for high-torque engines it is necessary to use springs of low stiffness and having a large relative movement. One way to obtain a result of this kind is to dispose springs in series. However, in prior art torsion dampers the relative movement is generally limited, of the order of 35°, or necessitates a complex and bulky architecture as well as a large number of components.

The present invention therefore aims to provide a solution enabling production of a torsion damper with a large relative movement, of small overall size and necessitating a limited number of components to reduce the costs of a torsion damper of this kind.

To this end the present invention concerns a torsion damper between an input first element and an output second element mounted mobile in rotation relative to one another about a rotation axis X, comprising:

at least one internal first spring,

at least one external second spring,

a first guide washer of the at least one internal first spring,

a second guide washer of the at least one external second spring,

in which one of the guide washers includes at least one phasing member configured to come into contact with the at least one spring guided by the other guide washer to take up the force transmitted by said at least one spring guided by the other guide washer.

The use of an internal spring, an external spring and a guide washer including a phasing member makes it possible to produce a compact torsion damper with high relative movement and comprising a reduced number of components, which simplifies assembly and reduces production costs.

According to a supplementary aspect of the present invention, the internal first spring is guided by a single guide washer.

According to a supplementary aspect of the present invention, the external second spring is guided by a single guide washer.

According to a supplementary aspect of the present invention, the first guide washer comprises:

a central part that extends transversely,

a peripheral part the section of which is curved and which forms a first guide intended partly to surround the first spring,

and the second guide washer comprises:

a central part that extends transversely,

a peripheral part the section of which is curved and which forms a second guide intended partly to surround the second spring,

the first guide washer including a first face on the concave side of the first guide and a second face on the convex side of the first guide and the second guide washer including a first face on the concave side of the second guide and a second face on the convex side of the second guide, the first face of the first guide washer being disposed facing the first face of the second guide washer.

According to a supplementary aspect of the present invention, the radial section of the peripheral part of the first guide washer forms a circular arc of between 180 and 260° relative to the centre of the first spring, said circular arc extending from the radial plane of the central part of the first guide washer and the radial section of the peripheral part of the second guide washer forms a circular arc of between 160 and 210° relative to the centre of the second spring, said circular arc extending from the radial plane of the central part of the second guide washer.

According to a supplementary aspect of the present invention, the internal first spring and the external second spring are disposed in series.

According to a supplementary aspect of the present invention, the springs are curved springs.

According to a supplementary aspect of the present invention, the internal first spring and the external second spring extend in a concentric manner around the rotation axis X.

According to a supplementary aspect of the present invention, the first guide washer has the general shape of a disc with an opening at the centre around which are disposed, on a first transverse angular section of the periphery of the disc, torus portions forming the first guide and, on a second transverse angular section of the periphery of the disc different from the first part, the phasing members.

According to a supplementary aspect of the present invention, the torsion damper includes two internal first springs and two external second springs, the first guide washer comprising two diametrically opposite phasing members that are disposed on the one hand between the two internal first springs and on the other hand between the two external second springs.

According to a supplementary aspect of the present invention, the first transverse angular section of the periphery of the disc corresponds to a total angular section between 310 and 350 degrees and the second transverse angular section of the periphery of the disc corresponds to a total transverse angular section between 10 and 50 degrees.

According to a supplementary aspect of the present invention, the phasing members extend radially.

According to a supplementary aspect of the present invention, the phasing members have a substantially trapezoidal shape.

According to a supplementary aspect of the present invention, the torsion damper further includes circular cups disposed at the end of the springs at the interface with the phasing members and the phasing members extend so that the isobarycentre of the points of contact with the cups is situated inside a circle the radius of which is half the radius of the cup.

According to a supplementary aspect of the present invention, the phasing members trace out at the level of the cup of the internal first spring a circular arc of between 160° and 200° about the centre of the internal first spring and trace out at the level of the cup of the external second spring an L-shape the right angle of which is situated substantially at the level of the centre of the external second spring.

According to a supplementary aspect of the present invention, the torsion damper further includes a plate coupled in rotation to the output second element and intended to come into contact with the internal first spring or an input plate coupled in rotation to the input first element and intended to come into contact with the external second spring.

According to a supplementary aspect of the present invention, the torsion damper further includes a pendular device configured to damp acyclic phenomena transmitted to the torsional damper.

The present invention also concerns a motor vehicle including a torsion damper as described above.

Other features and advantages of the invention will emerge from the following description given by way of nonlimiting example with reference to the appended drawings, in which:

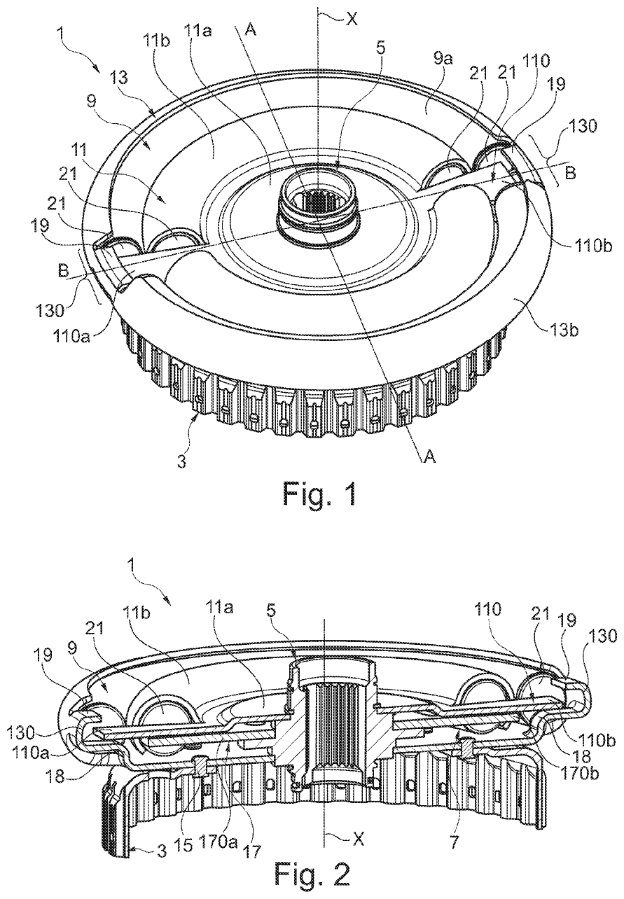

FIG. 1 represents a diagrammatic perspective view of a torsion damper according to a first embodiment of the present invention,

FIG. 2 represents a diagrammatic perspective view in section on a first radial plane B-B of the torsion damper from FIG. 1,

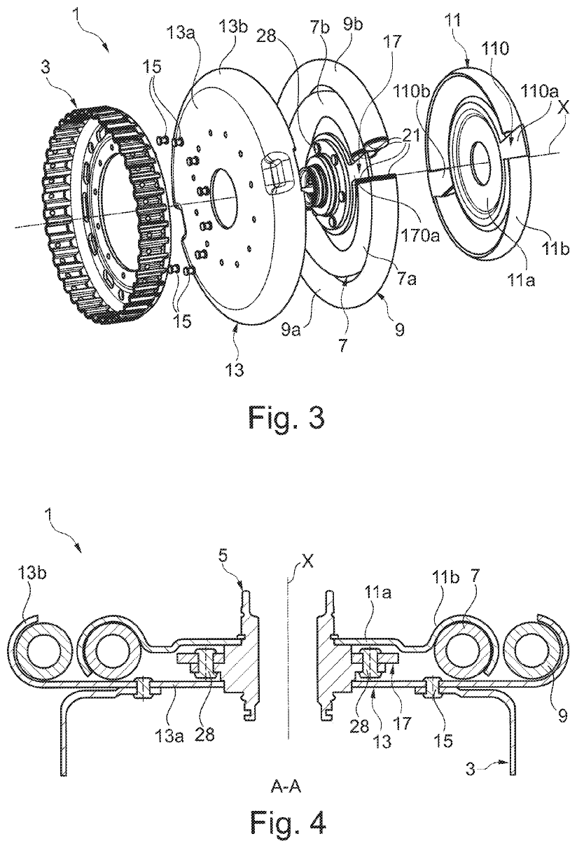

FIG. 3 represents a diagrammatic exploded view of the torsion damper from FIG. 1,

FIG. 4 represents a diagrammatic view in section on a second radial plane A-A of the torsion damper from FIG. 1,

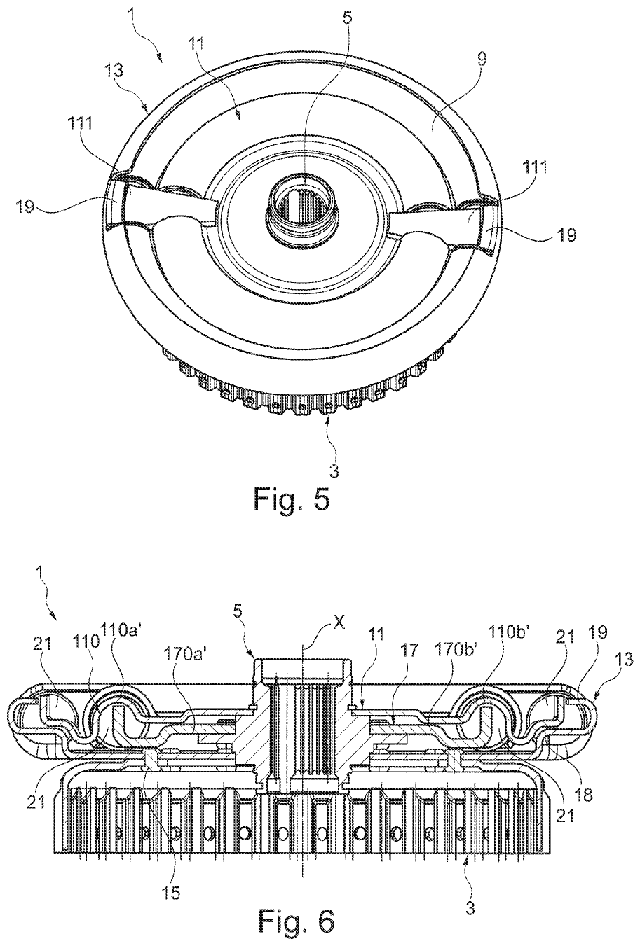

FIG. 5 represents a perspective view of a torsion damper including reinforcements,

FIG. 6 represents a diagrammatic view in section on a first radial plane of a torsion damper according to a second embodiment of the present invention,

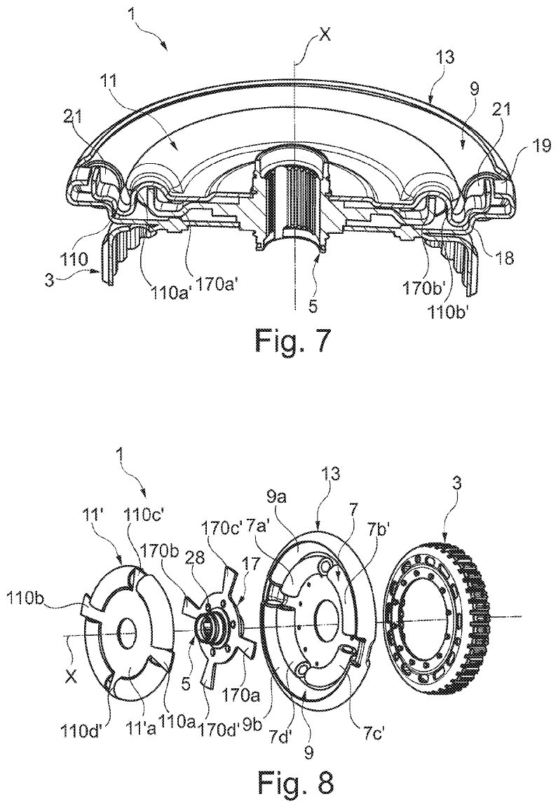

FIG. 7 represents a diagrammatic perspective view in section on a radial plane of a torsion damper according to the second embodiment of the present invention,

FIG. 8 represents a diagrammatic exploded view of a torsion damper according to a third embodiment,

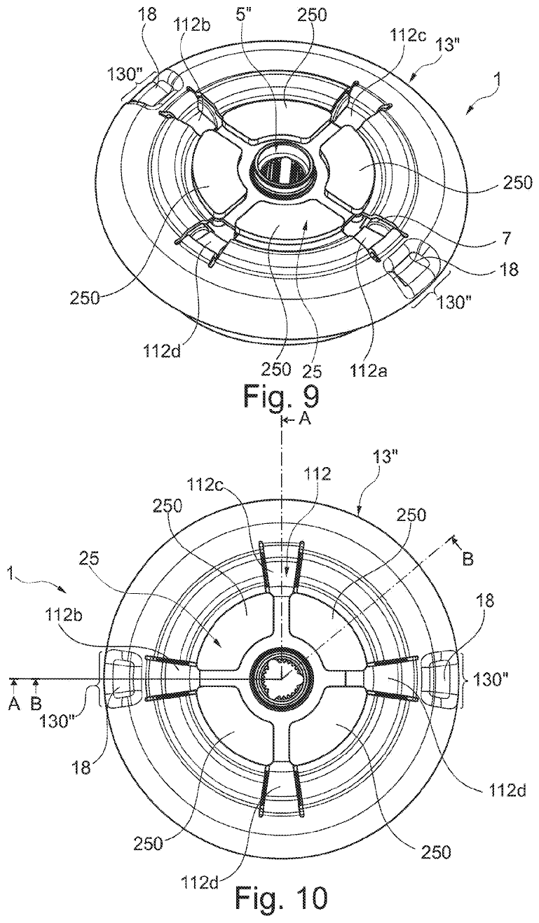

FIG. 9 represents a diagrammatic perspective view of a torsion damper according to a fourth embodiment of the present invention,

FIG. 10 represents a view from above of a torsion damper according to the fourth embodiment of the present invention,

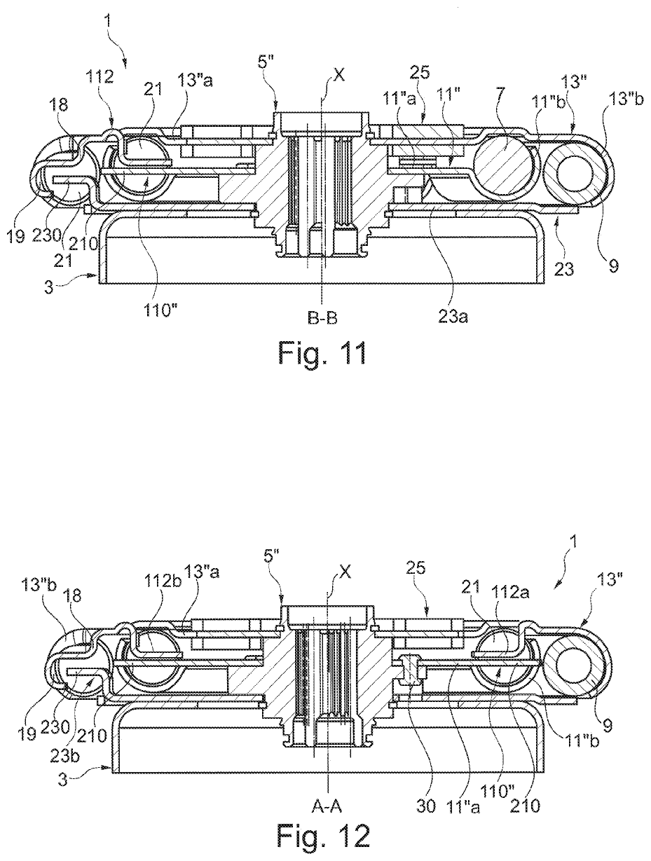

FIG. 11 represents a view in section taken along the line B-B in FIG. 10,

FIG. 12 represents a view in section taken along the line A-A in FIG. 10.

Elements identical or having the same function bear the same reference numbers in all the figures.

The following embodiments are examples. Although the description refers to one or more embodiments, this does not necessarily mean that each reference concerns the same embodiment or that the features apply only to one embodiment. Single features of different embodiments can also be combined or interchanged to provide other embodiments.

In the following description the terms “first”, “second”, “second”, etc, for example “first spring”, “second spring”, are merely used for indexing the elements in order to name and to distinguish elements that are similar but not identical. This indexing does not imply any priority of one element relative to another and names of this kind can easily be interchanged without departing from the scope of the present description. This indexing does not imply an order in time either.

In the remainder of the description the terms “axial”, “radial” and “transverse” used to define the orientation of the elements of the torsion damper are referred to the rotation axis X of the torsion damper and respectively define a direction parallel to the rotation axis X, a plane containing the rotation axis X and a plane perpendicular to the rotation axis X.

### First Embodiment

FIGS. 1 to 3 represent diagrammatic views of a motor vehicle torsion damper 1 according to a first embodiment of the present invention. FIG. 1 is a perspective view of the torsion damper 1, FIG. 2 is a perspective view in section on a radial plane B-B of the torsion damper 1 and FIG. 3 is an exploded perspective view of the torsion damper 1.

The torsion damper 1 comprises a first element 3 termed the input element and here in the form of a clutch disc support 3 and a second element 5 termed the output element and here in the form of a hub 5 intended to be coupled for example to a gearbox of the motor vehicle. The input element 3 and the output element 5 are mounted mobile in rotation relative to one another about a rotation axis X. Also, the torsion damper 1 includes elastic damping means disposed between the input element 3 and the output element 5. Here the elastic damping means take the form of an internal first spring 7 and an external second spring 9 disposed around the internal first spring 7, the two springs 7 and 9 being disposed in a concentric manner around the rotation axis X. Here the springs 7 and 9 are curved springs. The springs 7 and 9 can be produced as a number of parts, the various parts of the same spring 7, 9 being coupled in parallel. It is equally possible to have sets of springs coupled in series, said sets being coupled in parallel. In the present instance the internal first spring 7 comprises a first part 7a and a second part 7b separate from one another (the two parts 7a and 7b forming the internal spring 7) and the external second spring 9 likewise comprises a first part 9a and a second part 9b separate from one another (the two parts 9a and 9b forming the external spring 9). However, a one-piece spring or a spring comprising more than two parts is equally possible, likewise a different number of parts for the internal first spring 7 and the external second spring 9. When the number of parts is different for the internal first spring 7 and for the external second spring 9, the geometry of the phasing or guide washers described hereinafter has to be adapted. An embodiment with a four-part first spring 7 is represented in FIG. 8 and is described in more detail hereinafter.

The torsion damper 1 also includes a first guide washer 11 associated with the internal first spring 7 and a second guide washer 13 associated with the external second spring 9 that are described further hereinafter.

Also, one of the guide washers 11 or 13, here the first guide washer 11, includes a phasing member 110 intended to come into contact with the external second spring 9, in particular with one end of the external second spring 9, thus making it possible to take up the force transmitted by the external second spring 9 guided by the second guide washer 13 and thus to couple the internal first spring 7 in series with the external second spring 9. Because of the two-part springs 7 and 9, here the phasing member 110 comprises two diametrically opposite wings 110a and 110b. By coupling in series is meant that the first spring is situated between a first element and a second element and the second spring is disposed between the second element and a third element with the result that the two springs are not necessarily compressed in the same manner. Conversely, in a parallel coupling, the first spring and the second spring are situated between a first element and a second element with the result that the two springs are compressed in the same manner.

In the first embodiment shown in FIGS. 1 to 3 the input element 3 is coupled in rotation to the second guide washer 13, for example by rivets 15. In the present instance, twelve rivets 15 are used but a different number of rivets and other fixing means (bolts, welds, etc) can equally be used. In the same manner, for the other elements fixed by rivets, a different number of rivets or some other fixing means is equally covered by the present invention.

### Plate 17

The torsion damper 1 also includes a plate 17 coupled in rotation to the output element 5. The plate 17 is for example disposed axially between the two guide washers 11 and 13. The plate 17 can comprise two diametrically opposite wings 170a and 170b intended to come into contact with the internal first spring 7, in particular with one end of the internal first spring 7. The wings 170a and 170b are for example plane and are intended to extend in a transverse plane over a length less than the outside radius of the first spring 7 when mounted in the first guide washer 11 with the result that the wings 170a and 170b do not extend beyond the circle defined by the outside diameter of the first spring 7. The wings 170a and 170b can have a substantially trapezoidal shape that widens in the transverse plane in the direction away from the rotation axis X in the assembled state of the torsion damper 1. However, other, notably non-plane, shapes of the wings 170a and 170b can equally be used. The plate 17 is for example fixed to the hub 5 by rivets 28.

### First Guide Washer 11

The first guide washer 11 comprises a disc-shaped central part 11a with an opening at the centre that extends substantially transversely and a peripheral part 11b the radial section of which is curved and which forms a first guide intended partly to surround the internal first spring 7 as can be seen better in the FIG. 4 view in radial section taken along the line A-A. The peripheral part 11b can be divided into a number of parts, here two parts, corresponding to the various parts of the first spring 7. The various parts of the peripheral part 11b are separated by the phasing member 110 of the first guide washer 11 formed by rings 110a and 110b.

The radial section of the peripheral part 11b of the first guide washer 11 forms a circular arc of between 180 and 260° relative to the centre of the internal first spring 7. The circular arc extends from the transverse plane of the central part 11a of the first guide washer 11. The first guide is therefore a torus portion that surrounds the internal first spring 7 over a circular arc of between 180° and 260° relative to the centre of the internal first spring 7.

The wings 110a and 110b of the phasing member 110 are for example plane and intended to extend in a transverse plane over a length greater than the outside radius of the first guide of the first guide washer 11 and less than or equal to the outside radius of the second spring 9 when mounted in the second guide washer 13. The wings 110a and 110b can have a substantially trapezoidal shape that widens in the transverse plane in the direction away from the rotation axis X in the assembled state of the torsion damper 1. The wings 110a and 110b extend for example over an angle between 5 and 25° relative to the rotation axis X in the transverse plane, the peripheral part 11b extending over the rest of the periphery of the first guide washer 11.

Thus the peripheral part 11b of the first guide washer 11 extends for example over a total transverse angular section (formed here of two sections) of between 310 and 350° around the disc of the central part 11a and the phasing member 110 extends for example over a second total transverse angular section (formed here of two separate sections) of between 10 and 50°.

The first guide washer 11 thus has the general shape of a Frisbee™ with an opening at the centre except for two angular sections comprising the rings 110a and 110b of the phasing member 110.

The first guide washer 11 is mounted to pivot about the rotation axis X around the hub 5.

### Second Guide Washer 13

The second guide washer 13 comprises a disc-shaped central part 13a with an opening at the centre that extends substantially transversely and a peripheral part 13b the radial section of which is curved and forms a second guide intended partly to surround the external second spring 9. The peripheral part 13b can be divided into a number of parts, here two parts, corresponding to the various parts of the external second spring 9. The various parts are separated by connecting parts 130 comprising at least one projection intended to come up against one end of the external second spring 9. A connecting part 130 comprises for example two projections. The connecting part 130 is for example based on a curved portion such as the peripheral part 13b on which an internal protrusion 18 has been formed, for example by pressing, and a rim 19 projecting toward the interior of the curved section has been produced, for example by cutting and bending the curved portion. This internal protrusion 18 and this rim 19 are therefore intended to extend toward the interior of the radial section of the external second spring 9. The present invention is not limited to this configuration of the connecting part 130 but rather encompasses all configurations of the connecting part 130 allowing the second guide washer 13 to come to bear against the end of the external second spring 9.

Apart from the connecting parts 130, the radial section of the peripheral part 13b of the second guide washer 13 forms a circular arc of between 160 and 210° relative to the centre of the external second spring 9 as can be seen better in FIG. 4. The circular arc extends from the transverse plane of the central part 13a of the second guide washer 13. The second guide is therefore a torus portion that surrounds the external second spring 9 over a circular arc of between 160° and 210° relative to the centre of the external second spring 9.

The peripheral part 13b of the second guide washer 13 extends for example over a first transverse angular section (formed here of two separate sections) of between 310 and 350° around the disc of the central part 13a and the connecting part 130 (formed here of two separate connecting parts) extends over a second transverse angular section of between 10 and 50°.

The second guide washer 13 therefore has the general shape of a Frisbee™ with an opening at the centre.

The second guide washer 13 is mounted to pivot about the rotation axis X around the hub 5.

The connecting parts of the second guide washer 13 are configured to face the wings 110a and 110b of the phasing member 110 in the rest state of the torsion damper 1.

### Orientation Relative to One Another of the First Guide Washer 11 and the Second Guide Washer 13

A first face of the first guide washer 11 is defined as being the face situated on the concave side of the first guide, a second face of the first guide washer 11 as being the face situated on the convex side of the first guide, a first face of the second guide washer 13 as being the face situated on the concave side of the second guide and a second face of the second guide washer 13 as being the face situated on the convex side of the second guide. The first guide washer 11 and the second guide washer 13 are configured so that in the assembled state of the torsion damper 1 the first face of the first guide washer 11 faces the first face of the second guide washer 13. A configuration of this kind makes it possible to reduce the overall size and in particular the axial height of the torsion damper 1.

Also, the torsion damper 1 can equally include circular cups 21 intended to be disposed at the ends of the internal first spring 7 and of the external second spring 9. The circular cups 21 for example take the form of a disc the radius of which substantially corresponds to the radius of the spring. The circular cups 21 are for example clipped to the end of the springs 7, 9. These cups 21 enable take-up of the forces linked to a guide washer, a phasing member or a plate bearing on the internal first spring 7 or the external second spring 9 and thus to prevent an imbalance at the level of bearing against the end of the springs 7, 9.

In order further to improve the bearing interengagement between the springs 7 and 9 and the elements that come to bear on the springs 7 and 9, the shape of the radial section of the guide washers 11 and 13 and of the plate 17 can be determined so that the isobarycentre of the points of contact between these elements and the circular cups 21 are situated as close as possible to the centre of the circular cup 21 and notably inside a circle the radius of which is half the radius of the circular cup 21.

Also, the phasing member 110 can include reinforcements 111 as shown in FIG. 5. The reinforcements 111 are for example produced by pieces mounted on and fixed to the wings 110a and 110b of the phasing member 110. These reinforcements 111 are the same shape as the wings 110a and 110b and are for example welded, glued or riveted to the wings 110a and 110b. These reinforcements 111 on the one hand enable reinforcement of the wings 110a and 110b to reduce the wear thereof over time and on the other hand increase the bearing area between on the one hand the wings 110a and 110b and the external second spring 9 and on the other hand the wings 110a and 110b and the internal first spring 7.

### Second Embodiment

FIGS. 6 and 7 represent a second embodiment in which the wings 170a′ and 170b′ of the plate 17 no longer extend in a transverse plane but rather have a radial section featuring curvatures so that the isobarycentre of the bearing points on the circular cup 21 associated with the internal first spring 7 are near the centre of the circular cup 21. The wings 170a′ and 170b′ of the plate 17 comprise for example an end part which in the assembled state of the torsion damper 1 extends substantially axially and is disposed facing the centre of the circular cup 21 of the internal spring 7. The end part is extended by a right-angled curvature substantially at the level of the periphery of the circular cup 21 of the internal first spring 7, this curvature making it possible to connect the end part to a proximal part nearer the rotation axis X that extends substantially transversely.

Also, the wings 110a′ and 110b′ of the phasing element 110 also have a different shape and no longer extend in a transverse plane but rather have a radial section featuring curvatures on the one hand to be compatible with the shape of the wings 170a′ and 170b′ of the plate 17 and on the other hand so that the isobarycentre of the bearing points on the circular cup 21 associated with the external second spring 9 are near the centre of the circular cup 21. Thus the wings 110a′ and 110b′ comprise an intermediate part intended to come to face the cup 21 of the internal first spring that forms a circular arc substantially similar to the circular arc formed by the first guide, for example of between 160 and 200°, enabling it to circumvent the end part of the wings 170a′ and 170b′ of the phasing element 17, and an L-shaped end part. The base of the L extends transversely, the right-angled curvature of the L is intended to come substantially to face the centre of the circular cup 21 associated with the external second spring 9 and the end of the wing 110a′, 110b′ extends axially. This disposition of the wings 110a′ and 110b′ of the phasing element 110 therefore makes it possible for them to circumvent the internal protrusion 18 and the rim 19 of the second guide washer 13. The other elements of the torsion damper 1 are identical to the first embodiment and only the differences have been described.

### Third Embodiment

As indicated above the internal first spring 7 and the external second spring 9 can have different numbers of parts. FIG. 8 represents an exploded view of a torsion damper 1 according to a third embodiment in which the external second spring 9 comprises two parts 9a and 9b while the external first spring 7 comprises four parts 7a′, 7b′, 7c′ and 7d′.

The external second spring 9 and the second guide washer 13 are identical to the first embodiment described above.

The fourth parts 7a′, 7b′, 7c′ and 7d′ of the internal first spring 7 are intended to be distributed in the first guide washer 11 around the rotational axis X in the assembled state of the torsion damper 1. Also, to enable parallel coupling of the four parts 7a′, 7b′, 7c′ and 7d′ of the internal first spring 7 the first guide washer 11′ differs from the first guide washer 11 of the first embodiment in that it includes a third wing 110c′ and a fourth wing 110d′ which are diametrically opposite and disposed at 90° from the first wing 110a and the second wing 110b. The third and fourth wings 110c′ and 110d′ are disposed around the central part 11′a, which is similar to the central part 11a of the first embodiment, and are intended to come into contact with the internal first spring 7, in particular with one end of the internal first spring 7.

The shape of the third and fourth wings 110c′ and 110d′ is for example identical to the shape of the first and second wings 110a and 110b. Thus the third and fourth wings 110c′ and 110d′ are for example plane and are intended to extend in a transverse plane over a length less than or equal to the outside radius of the first guide of the first guide washer 11. The third and fourth wings 110c′ and 110d′ are therefore shorter than the first and second wings 110a and 110b. The third and fourth wings 110c′ and 110d′ can have a substantially trapezoidal shape that widens in the transverse plane in the direction away from the rotation axis X in the assembled state of the torsion damper 1. The third and fourth wings 110c′ and 110d′ extend for example over an angle of between 5 and 25° relative to the axis X in the transverse plane.

Thus the peripheral part 11b′ of the first guide washer 11′ extends for example over a first transverse angular section (formed here of four separate sections) of between 260 and 340° around the disc of the central part 11a and the phasing member 110 extends for example over a second transverse angular section (formed here of four separate sections) of between 20 and 100°. The third and fourth wings 110c′ and 110d′ are not in contact with the external second spring 9 but provide the parallel coupling of the four parts of the internal first spring.

The plate 17′ differs from the plate 17 of the first embodiment in that it includes third and fourth wings 170c′ and 170d′ in addition to the wings 170a and 170b. The third and fourth wings 170c′ and 170d′ are diametrically opposite and are disposed at 90° to the wings 170a and 170b. The third and fourth wings 170c′ and 170d′ are intended to come into contact with the internal first spring 7, in particular with one end of the internal first spring 7. The third and fourth wings 170c′ and 170d′ are for example plane and are intended to extend in a radial plane over a length less than the outside radius of the first spring 7 when mounted in the first guide washer 11. The third and fourth wings 170c′ and 170d′ can have a substantially trapezoidal shape that widens in the transverse plane in the direction away from the rotation axis X in the assembled state of the torsion damper 1. However, other, notably non-plane, shapes of the wings 170c′ and 170d′ can equally be used.

The other elements of the torsion damper 1 are identical to the first embodiment and only the differences have been described.

Although this third embodiment has been described with an internal first spring 7 in four parts and an external second spring 9 in two parts, springs with a different number of parts, for example an internal first spring 7 with three parts and/or an external second spring 9 with one or four parts or any other number of parts can equally be envisaged in the context of the present invention, the number, the shape and the position of the phasing elements of the guide washers then being modified accordingly to match the springs.

### General Operation of the Torsion Damper 1

In operation, rotation of the input element 3, i.e. of the disc support 3 connected to a clutch device, drives rotation of the second guide washer 13 which is coupled in rotation to the disc support by the rivets 15. This rotation of the second guide washer 13 compresses the external second spring 9 by way of the internal protrusion 18 and the rim 19. The compression of the external second spring 9 causes rotation of the first guide washer 11 by virtue of bearing on the phasing element 110. Rotation of the first guide washer then causes compression of the internal first spring 7. The compression of the internal first spring 7 causes rotation of the output element 5, i.e. the hub 5, via the plate 17 that is coupled in rotation to the hub by rivets 28.

### Fourth Embodiment

According to a fourth embodiment shown in FIGS. 9 to 12, a phasing member 112 is carried by the second guide washer 13 and not by the first guide washer 11 as in the previous embodiments. Also, in this embodiment the torsion damper 1 includes a pendular device 25 making it possible to improve the filtration of acyclic phenomena. It is to be noted that a pendular device 25 of this kind can also be disposed on the torsion dampers 1 as described for the previous embodiment. The pendular device 25 is disposed on one of the elements of the torsion damper 1, here the guide washer 11, but the pendular device 25 can equally be disposed on the disc support 3 or the hub 5 for example.

FIG. 9 is a perspective view of a torsion damper according to the fourth embodiment, FIG. 10 is a view from above and FIGS. 11 and 12 are views in section taken along the lines B-B and A-A respectively in FIG. 10. In this embodiment the internal first spring 7 comprises four parts and the external second spring 9 comprises two parts.

In this embodiment the disc support 3 is no longer coupled in rotation to the second guide washer 13″ but instead is coupled to an input plate 23 as can be seen better in FIGS. 11 and 12.

### Input Plate 23

This input plate 23 is mounted mobile in rotation relative to the hub 5″ and is configured to come into contact with the external second spring 9, notably with one end of the external second spring 9. The input plate 23 comprises for example a disc-shaped central part 23a with an opening at the centre that extends transversely in the assembled state of the torsion damper 1 and an end part 23b that comprises two diametrically opposite arms 230. The radial section of the arms 230 forms for example a step and the end of the arm 230 extends transversely and substantially faces the centre of the external second spring 9.

### Second Guide Washer 13″

The second guide washer 13″ comprises a disc-shaped central part 13″a with an opening at the centre that extends substantially transversely in the assembled state of the torsion damper 1 and a peripheral part 13″b the radial section of which is curved and which forms a second guide intended partly to surround the external second spring 9. The pendular device 25 is disposed at the level of the central part 13″a and comprises four weights 250 mounted mobile relative to the second guide washer 13″. Thus on rotation of the second guide washer 13″ the weights 250 can move relative to the second guide washer 13″, these movements being limited, for example to a few millimetres or centimetres. The pendular device 25 enables the efficacy of the torsion damper 1 to be improved.

Also, the central part 13″a of the second guide washer 13″ comprises four angular sections in which the phasing member 112 is arranged. The phasing member 112 therefore comprises four wings 112a, 112b, 112c and 112d equally distributed relative to the rotation axis X, i.e. separated by 90°. The wings 112a, 112b, 112c and 112d are for example produced by cutting and bending the central part 13″a of the second guide washer 13″. The wings 112a, 112b, 112c and 112d extend for example from the periphery of the central part 13″a of the second guide washer 13″ toward the centre of the guide washer 13″. Other configurations of the phasing member 112 are equally possible.

The radial section of the wings 112a, 112b, 112c and 112d forms for example a step and the end of the wings extends transversely and substantially faces the centre of the internal first spring 7.

The peripheral part 13″b can be divided into a plurality of parts, here two parts, corresponding to the various parts of the external second spring 9. The various parts are separated by connecting parts 130″ including at least one projection intended to come up against one end of the external second spring 9. A connecting part 130″ comprises for example two projections. The connecting part 130″ is for example produced from a curved portion such as the peripheral part 13″b on which an internal protrusion 18 is formed, for example by pressing, and a rim 19 projecting toward the interior of the curved section is produced for example by cutting and bending the curved portion. This internal protrusion 18 and this rim 19 are therefore intended to extend toward the interior of the radial section of the external second spring 9. The present invention is not limited to this configuration of the connecting part 130″ but encompasses all configurations of the connecting part 130″ allowing the second guide washer 13″ to come to bear against the end of the external second spring 9.

Apart from the connecting parts 130″, the radial section of the peripheral part 13″b of the second guide washer 13″ forms a circular arc of between 160 and 210° relative to the centre of the external second spring 9 as can be seen better in FIGS. 11 and 12. The circular arc extends from the transverse plane of the central part 13″a of the second guide washer 13″. The second guide is therefore produced by a torus portion that surrounds the external second spring 9 over a circular arc of between 160° and 210° relative to the centre of the external second spring 9.

The peripheral part 13″b of the second guide washer 13 extends for example over a first transverse angular section (formed here of two separate sections) of between 310 and 350° around the disc of the central part 13″a and the connecting part 130″ (formed here of two separate connecting parts) extends over a second transverse angular section of between 10 and 50°.

The second guide washer 13″ is mounted to pivot about the rotation axis X around the hub 5″.

### First Guide Washer 11″

The first guide washer 11″, visible in FIGS. 11 and 12, comprises a disc-shaped central part 11″a with an opening at the centre that extends substantially transversely in the assembled state of the torsion damper 1 and a peripheral part 11″b the radial section of which is curved and which forms a first guide intended partly to surround the internal first spring 7 as can be seen in FIGS. 11 and 12. The peripheral part 11″b can be divided into a plurality of parts, here four parts, corresponding to the various parts of the first spring 7. The various parts of the peripheral part 11″b are separated by a member 110″ of the first guide washer 11″ formed by four wings 210 providing the parallel arrangement of the four parts of the first spring 7.

The radial section of the peripheral parts 11″b of the first guide washer 11″ forms a circular arc of between 180 and 260° relative to the centre of the internal first spring 7. The circular arc extends from the transverse plane of the central part 11″a of the first guide washer 11. The first guide is therefore a torus portion that surrounds the internal first spring 7 over a circular arc of between 180° and 260° relative to the centre of the internal first spring 7.

The wings 210 of the member 110″ are for example plane and are intended to extend in a transverse plane over a length less than or equal to the outside radius of the first guide of the first guide washer 11. The wings 210 can have a substantially trapezoidal shape that widens in the transverse plane in the direction away from the rotation axis X. Each wing 210 extends for example over an angle of between 5 and 25° relative to the axis X in the transverse plane, the peripheral part 11″b extending over the rest of the periphery of the first guide washer 11″.

Thus the peripheral part 11″b of the first guide portion 11 extends for example over a first transverse angular section (formed here of four separate sections) of between 260 and 340° around the disc of the central part 11″a and the member 110″ extends for example over a second transverse angular section (formed here of four separate sections) of between 20 and 100°.

The first guide washer 11″ therefore has the general shape of a Frisbee™ with an opening at the centre except for four angular sections comprising the wings 210 of the member 110″.

The first guide washer 11″ is coupled in rotation with the hub 5″, for example by rivets 30.

In the rest state of the torsion damper 1 the wings 210 of the member 110″ are configured to face the connecting parts of the second guide washer 13″.

### Orientation Relative to One Another of the First Guide Washer 11″ and the Second Guide Washer 13″

As in the first embodiment, a first face of the first guide washer 11″ is defined as being the face situated on the concave side of the first guide, a second face of the first guide washer 11″ as being the face situated on the convex side of the first guide, a first face of the second guide washer 13″ as being the face situated on the concave side of the second guide, and a second face of the second guide washer 13″ as being the face situated on the convex side of the second guide. The first guide washer 11″ and the second guide washer 13″ are configured so that in the assembled state of the torsion damper 1 the first face of the first guide washer 11″ is disposed facing the first face of the second guide washer 13″. A configuration of this kind enables the overall size and in particular the axial height of the torsion damper 1 to be reduced.

### General Operation of the Torsion Damper 1

The operation of this fourth embodiment differs from the first three embodiments in particular by virtue of the position of the input plate 23 connected to the input element, i.e. the disc support 3, instead of the plate 17 connected to the output element, i.e. the hub 5.

Thus in operation, upon rotation of the input element 3, i.e. of the disc support 3 connected to a clutch device, the disc support 3 compresses the external second spring 9 via the input plate 23, which guides rotation of the second guide washer 13″ (and consequently where applicable the movement of the weights 250 of the pendular device 25) by way of the internal protrusion 18 and the rim 19. Rotation of the external second spring 9 compresses the internal first spring 7 by way of the phasing member 112. Compression of the internal first spring 7 causes rotation of the hub 5″ via the first guide washer 11″ coupled in rotation to the hub by rivets 30.

In the fourth embodiment the pendular device 25 is therefore connected to the second guide washer 13″ that carries the phasing member. The external second spring 9, situated on the path of transmission of torque between the input element 3 of the damper and the guide washer 13″, has an angular stiffness K1. The internal first spring 7, situated on the path of transmission of torque between the guide washer 13″ and the first guide washer 11″, has an angular stiffness K2. The ratio between the angular stiffness K2 and the angular stiffness K1 is advantageously at least equal to 2. The second guide washer 13″ that carries the phasing member has a resonant frequency that increases as the ratio K2/K1 increases. Having a ratio K2/K1 at least equal to 2 therefore enables the resonant frequency of the member of the second guide washer 13″ that carries the phasing member to be raised sufficiently to prevent the latter from being excited at low engine speeds. The resonant frequency of the member of the second guide washer 13″ that carries the phasing member can for example be reached only for engine speeds greater than 3000 or even greater than 4000 revolutions per minute.

Having a relatively low stiffness K1 also enables the torque transmission device to improve the filtering of the rotation acyclic phenomena and vibrations. The stiffness K1 being as close as possible to the source of the vibrations, it enables better filtering of these vibrations.

The ratio K2/K1 is preferably between 2 and 5, preferentially between 2 and 3.

As indicated above, in variants that are not shown, a pendular device 25 can also be disposed on the torsion dampers 1 described in the first, second and third embodiments. This ratio K2/K1 value applicable in the variants in which the pendular damping device is linked to a part that carries the phasing member. In these variants that are not shown of the first embodiment and the second embodiment the part that carries the phasing member is the first guide washer 11. In the variant that is not shown of the third embodiment the part that carries the phasing member is the first guide washer 11′. The ratio between the angular stiffness K2 of the internal first spring 7 and the angular stiffness K1 of the external second spring is advantageously at least equal to 2.

Some of the features described for the first three embodiments such as for example the circular cups 21 or the reinforcements 111 (at the level of the wings 210 or 112) can equally be used in this embodiment. Moreover, as in the other embodiments, the number of parts of the internal first spring 7 and the external second spring 9 can differ from the configuration shown in FIGS. 9 and 12.

In these various embodiments the internal first spring is guided by a single guide washer.

In these various embodiments the external second spring is guided by a single guide washer.

The present invention also concerns a motor vehicle including a torsion damper according to any of the embodiments described.

Thus using two curved springs disposed concentrically one around the other via guide washers and coupled in series by a phasing element disposed on one of the guide washers enables production of a torsion damper having a large relative movement whilst limiting the overall size and the number of parts needed, which reduces production cost and simplifies assembly. A configuration of this kind therefore makes it possible to produce a torsion damper with large relative movement at low cost.

1. Torsion damper (1) between an input first element (3) and an output second element (5) mounted mobile in rotation relative to one another about a rotation axis X, comprising:
at least one internal first spring (7),
at least one external second spring (9),
a first guide washer (11, 11″) of the at least one internal first spring (7),
a second guide washer (13, 13″) of the at least one external second spring (9), wherein one of the guide washers (11, 11″, 13, 13″) includes at least one phasing member (110, 112) configured to come into contact with the at least one spring (7, 9) guided by the other guide washer (11, 11″, 13, 13″) to take up the force transmitted by said at least one spring (7, 9) guided by the other guide washer (11, 11″, 13, 13″).

2. Torsion damper (1) according to claim 1 wherein the first guide washer (11, 11″) comprises:
a central part (11a, 11″a) that extends transversely,
a peripheral part (11b, 11″b) the section of which is curved and which forms a first guide intended partly to surround the first spring (7),
and the second guide washer (13, 13″) comprises:
a central part (13a, 13″a) that extends transversely,
a peripheral part (13b, 13″b) the section of which is curved and which forms a second guide intended partly to surround the second spring (9),
the first guide washer (13, 13″) including a first face on the concave side of the first guide and a second face on the convex side of the first guide and the second guide washer including a first face on the concave side of the second guide and a second face on the convex side of the second guide, the first face of the first guide washer (11, 11″) being disposed facing the first face of the second guide washer (13, 13″).

3. Torsion damper (1) according to claim 2 wherein the radial section of the peripheral part of the first guide washer (11, 11″) forms a circular arc of between 180 and 260° relative to the central of the first spring (7), said circular arc extending from the radial plane of the central part of the first guide washer (11, 11″) and the radial section of the peripheral part of the second guide washer (13, 13″) forms a circular arc of between 160 and 210° relative to the centre of the second spring (9), said circular arc extending from the radial plane of the central part of the second guide washer (13, 13″).

4. Torsion damper (1) according to claim 1 wherein the internal first spring (7) and the external second spring (9) are disposed in series.

5. Torsion damper (1) according to claim 1 wherein the springs (7, 9) are curved springs.

6. Torsion damper (1) according to claim 5 wherein the internal first spring (7) and the external second spring (9) extend in a concentric manner around the rotation axis X.

7. Torsion damper (1) according to claim 2 wherein the first guide washer (11, 11″) has the general shape of a disc with an opening at the centre around which are disposed, on a first transverse angular section of the periphery of the disc, torus portions forming the first guide and, on a second transverse angular section of the periphery of the disc different from the first part, the phasing members (110, 112).

8. Torsion damper (1) according to claim 1 comprising two internal first springs (7a, 7b) and two external second springs (9a, 9b), the first guide washer (11) comprising two diametrically opposite phasing members (110a, 110b) that are disposed on the one hand between the two internal first springs (7a, 7b) and on the other hand between the two external second springs (9a, 9b).

9. Torsion damper (1) according to claim 7 wherein the first transverse angular section of the periphery of the disc corresponds to a total angular section between 310 and 350 degrees and the second transverse angular section of the periphery of the disc corresponds to a total transverse angular section between 10 and 50 degrees.

10. Torsion damper (1) according to claim 7 wherein the phasing member (110a, 110b) extends radially.

11. Torsion damper (1) according to claim 10 wherein the phasing members (110a, 110b) have a substantially trapezoidal shape.

12. Torsion damper (1) according to claim 7 further including circular cups (21) disposed at the end of the springs (7, 9) at the interface with the phasing members (110a, 110b) and wherein the phasing members (110a, 110b) extend so that the isobarycentre of the points of contact with the cups (21) is situated inside a circle the radius of which is half the radius of the cup (21).

13. Torsion damper (1) according to claim 12 wherein the phasing members (110a, 110b) trace out at the level of the cup (21) of the internal first spring (7) a circular arc of between 160° and 200° about the centre of the internal first spring and trace out at the level of the cup (21) of the external second spring (9) an L-shape the right angle of which is situated substantially at the level of the centre of the external second spring (9).

14. Torsion damper (1) according to claim 1 further including a plate (17) coupled in rotation to the output second element (5) and intended to come into contact with the internal first spring (7) or an input plate (23) coupled in rotation to the input first element (3) and intended to come into contact with the external second spring (9).

15. Torsion damper (1) according to claim 1 further including a pendular device (25) configured to damp acyclic phenomena transmitted to the torsional damper (1).

16. Motor vehicle including a torsion damper (1) as claimed in claim 1.

17. Torsion damper (1) according to claim 2 wherein the internal first spring (7) and the external second spring (9) are disposed in series.

18. Torsion damper (1) according to claim 3 wherein the internal first spring (7) and the external second spring (9) are disposed in series.
